(19) United States
(12) Patent Application Publication
(10) Pub. No.: US 2009/0160338 A1
(43) Pub. Date: Jun. 25, 2009

(54) PLASMA DISPLAY PANEL AND FRONT PANEL THEREOF

(75) Inventors: Masayuki Wada, Miyazaki (JP); Fumiaki Yoshino, Miyazaki (JP); Tatsuhiko Kawasaki, Miyazaki (JP)

Correspondence Address: MILES & STOCKBRIDGE PC, 1751 PINNACLE DRIVE, SUITE 500, MCLEAN, VA, 22102-3833, US

(73) Assignee: Hitachi Plasma Display Limited, Miyazaki (JP)

(21) Appl. No.: 12/301,576

(22) PCT Filed: Jul. 19, 2006
(86) PCT No.: PCT/JP2006/314230

§ 371 Date: Nov. 19, 2008

(51) Int. Cl. H01J 17/49

(52) U.S. Cl. 313/587; 313/582

(57) ABSTRACT

A plasma display panel includes a magnesium oxide film (18) that covers electrodes (X, Y) and is exposed to a discharge gas space (31). The magnesium oxide film (18) includes silicon and calcium as impurities, and the content of the impurities in the magnesium oxide film (18) is 800 to 2050 ppm by weight. By suppressing the total content of silicon and calcium in the film to 800 to 2050 ppm by weight, the discharge start voltage can be reduced by no less than 20 volts.

### TECHNICAL FIELD

The present invention relates to a plasma display panel having a magnesium oxide film that covers electrodes, and particularly relates to improvements in magnesium oxide films.

### BACKGROUND ART

AC-type plasma display panels include an insulator that covers electrodes. The insulator is composed of a dielectric layer approximately 10 to 50 μm thick and a protective film approximately 0.5 to 1 μm thick that is laminated onto the dielectric layer. The dielectric layer is a layer for building a sufficient wall charge. The protective layer is made of a material with advanced anti-sputtering properties, and prevents the deterioration of the dielectric layer due to ion collisions occurring during discharge.

The protective layer is typically made of magnesium oxide (MgO, or magnesia). Because magnesium oxide is a high γ matter, a protective layer made of magnesium oxide has a property of easily emitting secondary electrons. Due to the emission of secondary electrons, the firing voltage drops, increasing the driving voltage margin.

With regards to the composition of such a protective layer that affects the discharge properties, JP 3247632B describes the usefulness of a magnesium oxide film containing silicon (Si) at a ratio of 500 to 10000 ppm in reducing the rate of occurrence of a display defect known as “black noise”.

Meanwhile, JP 2003-109511A proposes including silicon in a magnesium oxide film at a ratio of 500 to 15000 ppm and decreasing the amount of impurities such as potassium (K), calcium (Ca), iron (Fe), and chromium (Cr) contained therein to the greatest extent possible, as a means to improve discharge properties.

Furthermore, JP 2005-340206A proposes doping a magnesium oxide film with calcium, aluminum (Al), and silicon. 100 to 300 ppm for Ca, 60 to 90 ppm for Al, 60 to 90 ppm for Fe, and 40 to 100 ppm for Si are disclosed as preferable doping amounts.

### [Patent Document 1] JP 3247632B

### [Patent Document 2] JP 2003-109511A

### [Patent Document 3] JP 2005-340206A

### DISCLOSURE OF THE INVENTION

Increasing the speed of addressing is an issue related to the driving of a plasma display panel. If faster addressing is possible, more display lines can be scanned than is possible during present addressing periods, making it possible to increase the resolution of screens. Moreover, rather than increasing the display lines, increasing the sustain period by the amount by which the required time is shortened through faster addressing makes it possible to increase the number of display discharges and thus increase the luminosity.

A desirable cell structure for realizing faster addressing is a structure in which misaddressing does not occur even when the pulse width of the address pulse is short. Misaddressing occurs when the discharge delay time, from when a pulse is applied to when the discharge starts, is longer than the pulse width of the address pulse. Cells that easily discharge at a lower discharge start voltage (firing voltage) than presently available are necessary in order to reduce the rate of occurrence of misaddressing.

Having been conceived in light of such circumstances, it is an object of the present invention to provide a plasma display panel that has cells that easily discharge, thereby being useful for the improvement of display quality.

Upon investigating the relationship between the amount of impurities (also called “impurity concentration” hereinafter) in a magnesium oxide film and the discharge properties, it was discovered that the discharge properties in the case where silicon and calcium were included as the impurities and the total amount of these impurities was in the range of 800 to 2050 ppm were better than other cases. The present invention is based upon such circumstances.

A plasma display panel that achieves the aforementioned object includes a magnesium oxide film that covers electrodes and is exposed to a discharge gas space. The magnesium oxide film includes silicon and calcium as impurities, and the content of the impurities in the magnesium oxide film is 800 to 2050 ppm. In the present specification, the unit used for the contents is ppm, or more specifically, ppm by weight.

### BRIEF DESCRIPTION OF THE DRAWINGS

FIG. 1 is an exploded perspective view illustrating an example of the cell structure of a plasma display panel according to the present invention.

FIG. 2 is a graph illustrating the relationship between the total content of silicon and calcium, and discharge properties.

FIG. 3 is a graph illustrating the relationship between the content of calcium and discharge properties.

FIG. 4 is a graph illustrating the relationship between the content of silicon and discharge properties.

### BEST MODE FOR CARRYING OUT THE INVENTION

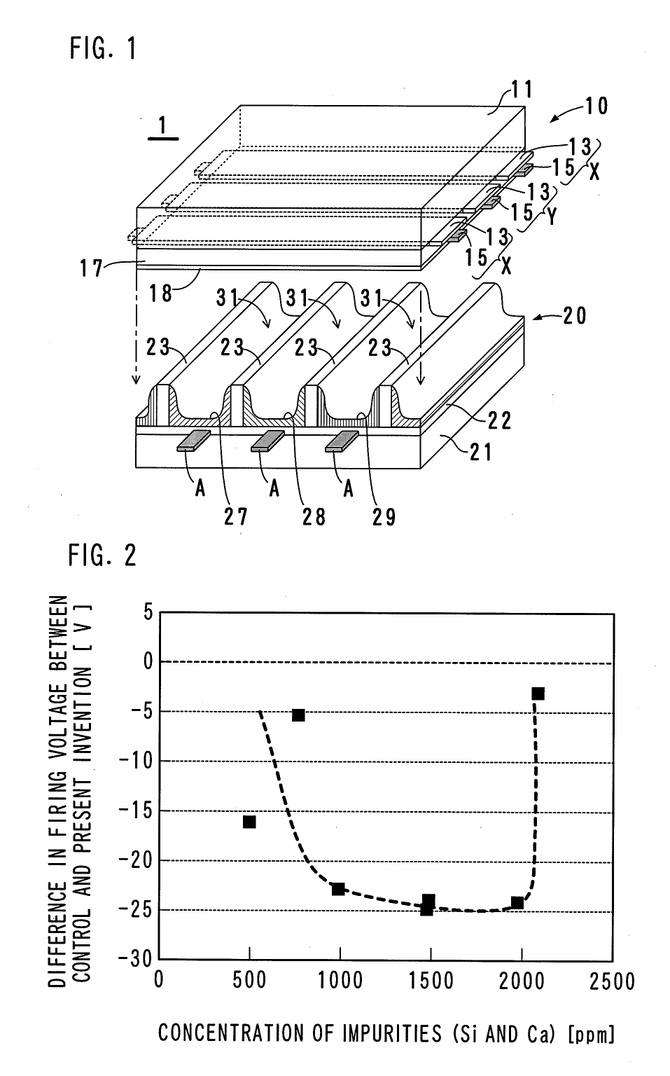

The present invention can be applied in various types of plasma display panels that include a magnesium oxide film for discharge. A plasma display panel 1, shown in FIG. 1, is one example thereof.

The plasma display panel 1 includes a front panel 10 and a back panel 20. In order to facilitate understanding of the internal structure, the front panel 10 and the back panel 20 are illustrated as being separate from each other in FIG. 1; however, in reality, the two panels make contact with each other. The front panel 10 includes: a glass substrate 11; display electrodes X, which are first electrodes; display electrodes Y, which are second electrodes; a dielectric layer 17 for AC driving; and a magnesium oxide film 18, serving as a protective layer that prevents sputtering from occurring on the dielectric layer 17. The rear panel 20 includes: a glass substrate 21; address electrodes A, which are third electrodes; a dielectric layer 22; multiple partitions 23; a red (R) fluorescent material 27; a green (G) fluorescent material 28; and a blue (B) fluorescent material 29.

In the front panel 10, the display electrodes X and display electrodes Y are disposed alternately at equal intervals on the inner surface of the glass substrate 11. All electrode gaps in this array serve as surface discharge gaps, and adjacent display electrodes X and display electrodes Y form electrode pairs for surface discharge. Each of these display electrodes is configured of a transparent conductive film 13 patterned in a wide band-shape, and a metallic film (bus conductor) 15 patterned in a narrow band-shape. Note that a structure in which independently-controllable electrode pairs correspond to the rows in a matrix display exists as another example of a display electrode array. The dielectric layer 17, which covers the display electrodes X and the display electrodes Y, is a low-melting point glass layer, approximately 30 μm thick, that spreads across the entire screen. Details of the magnesium oxide film 18 shall be given later.

In the back panel 20, the address electrodes A are arranged at the same pitch as the pitch at which the cells are arranged, and intersect with the display electrodes X and the display electrodes Y. The address electrodes A and the display electrodes Y of the front panel 10 form an electrode matrix for cell selection through address discharge. The partitions 23 are disposed in the electrode gaps in the address electrode array. Discharge gas spaces are created by the partitions 23 for each column in the matrix display, forming column spaces 31 corresponding to each column. The fluorescent material layers 27, 28, and 29 are disposed so as to cover the top surface of the dielectric layer 22 and the side surfaces of the partitions 23, and are excited by ultraviolet light emitted by the discharge gas, thereby emitting light.

The plasma display panel 1 configured as described thus far is manufactured through a process for creating the front panel 10 and the back panel 20, a process for joining the periphery portions of the front panel 10 and the back panel 20 to each other using an adhesive, a process for evacuating gas remaining in the internal space formed through the joining, and a process for filling the internal space that has been cleaned through the evacuation with a discharge gas.

When creating the front panel 10, the magnesium oxide film 18 is formed through vacuum deposition. Vacuum deposition is industrially proven, and is suited for mass production. The “vacuum deposition” mentioned here includes deposition combined with ion plating.

Hereinafter, the impurity concentration of the magnesium oxide film 18 according to a characteristic of the present invention shall be described.

Multiple plasma display panels with identical configurations save for differing impurity concentrations in the magnesium oxide films 18 were manufactured as samples for evaluating discharge properties (called “property samples” hereinafter). Prior to forming the magnesium oxide films 18 for the respective property samples, a powder obtained by adding silicon oxide and calcium oxide to a magnesium oxide powder that has a high purity, of no less than 99.95%, was sintered in pellet form. Through this procedure, multiple deposition materials with differing amounts of added oxides were created. Using these deposition materials, a magnesium oxide film approximately 800 nm thick was formed through reactive electron-beam evaporation.

The ranges of conditions for forming the film are as follows.

Deposition pressure: 0.005 to 0.15 Pa

Substrate temperature: 100 to 300° C.

Reactive gas: oxygen

The created property samples were connected to driving circuits, and tests that display test patterns were conducted. The test patterns are single-color stripe patterns with line gaps wide enough to allow ⅓ of cells in the selected display line to emit light. The driving sequence includes addressing and the subsequent sustain. In addressing, an address pulse is applied to the electrode gap between the display electrode Y and the address electrode A of the cell that is to emit light, thereby causing an address discharge for forming a wall charge. In sustain, a sustain pulse is applied to the electrode gaps between the display electrodes X and the display electrodes Y for all cells. The sustain pulse causes a display discharge to occur only in cells in which the wall charge was properly formed during addressing. If misaddressing has not occurred, the test pattern is displayed correctly during sustain.

During the tests, the peak value of the address pulse was gradually increased, and the peak value at which the all cells that were supposed to emit light actually emitted light was recorded as the discharge start voltage for address discharge. The same test was performed multiple times for each property sample, and the average of those results was taken as the measured value.

After the tests, the property samples were disassembled, and a 10 mm by 10 mm piece was cut out from the central portions of the front panels thereof as samples for the evaluation of impurity concentration (called “concentration samples” hereinafter).

The impurity concentration of the magnesium oxide film 18 in the concentration samples was measured using a secondary ionization mass spectrometer.

The results illustrated in FIG. 2 were obtained from the above tests and measurements. The horizontal axis of the graph in FIG. 2 corresponds to the sum of the concentrations of impurities, or silicon and calcium (the total impurity content), whereas the vertical axis corresponds to the difference between a control and the obtained discharge start voltage. Here, the control is a plasma display panel having a magnesium oxide film formed using a deposition material composed of the above-mentioned high-purity magnesium oxide powder to which impurities have not been added.

In FIG. 2, the discharge start voltage when the total impurity content is, for example, 800 ppm is approximately 23 volts lower than the discharge start voltage in the control. Based on FIG. 2, it can be seen that remarkably improved results, in which the discharge start voltage drops no less than 20 volts, can be obtained for the discharge properties by suppressing the total impurity content to 800 to 2050 ppm.

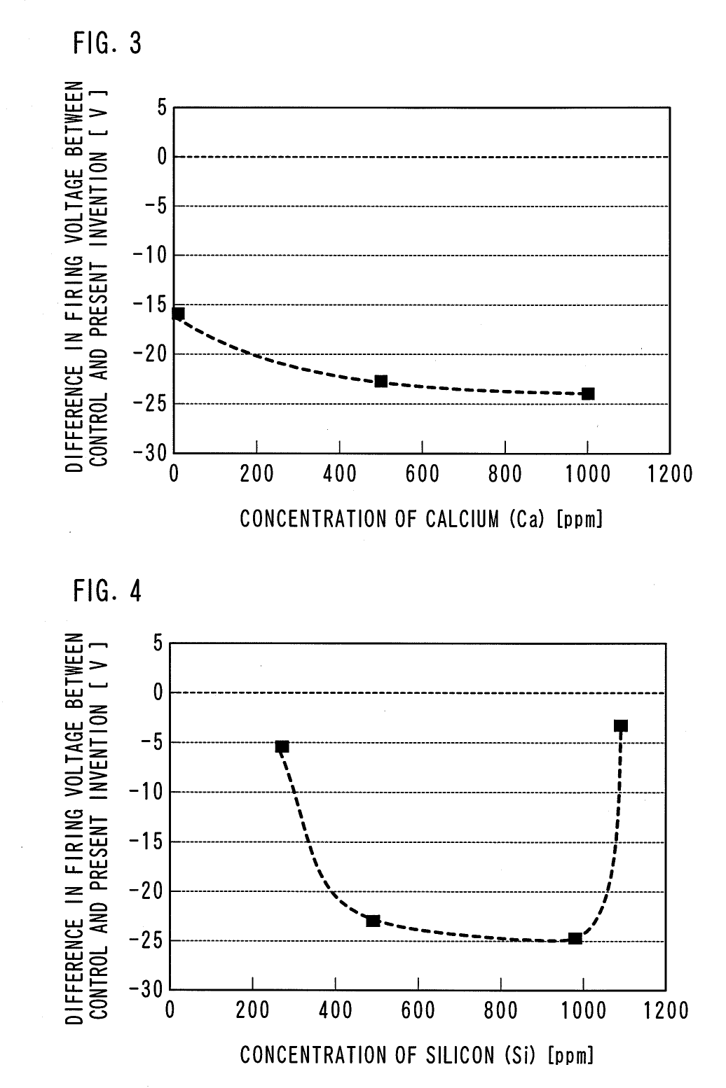

FIG. 3 illustrates the relationship between the discharge start voltage and a concentration where the silicon concentration is kept at 490 ppm while changing the calcium concentration in the range of 10 to 1000 ppm. The discharge start voltage is approximately 10 volts lower when the calcium concentration is no less than 500 ppm as compared to when the calcium concentration is 10 ppm. Based on FIG. 3, it can be seen that it is necessary to add no less than a certain amount of calcium in order to improve the discharge properties.

FIG. 4 illustrates the relationship between the discharge start voltage and a concentration where the calcium concentration is kept at 500 ppm while changing the silicon concentration in the range of 250 to 1100 ppm. Based on FIG. 2, it can be seen that remarkably improved results, in which the discharge start voltage drops no more than 20 volts, can be obtained for the discharge properties by suppressing the silicon concentration to 400 to 1050 ppm. Sufficiently improved results cannot be obtained when the silicon concentration is less than or equal to 400 ppm or greater than or equal to 1050 ppm.

In the abovementioned embodiment, various modifications can be made to the configuration of the plasma display panel 1 without departing from the essential spirit of the present invention. The thickness of the magnesium oxide film 18 may be greater than or equal to 500 nm, such as, for example, 500 to 1000 nm. The dielectric layer 17 is not limited to sintered glass, and may be vapor-grown film. A mesh patterned partition may be employed instead of the partition 23.

### INDUSTRIAL APPLICABILITY

The present invention contributes to the improvement of the performance of plasma display panels.

1. A plasma display panel comprising a magnesium oxide film that covers electrodes and is exposed to a discharge gas space,
wherein the magnesium oxide film includes silicon and calcium as impurities, and the content of the impurities is 800 to 2050 ppm.

2. The plasma display panel according to claim 1,
wherein the calcium content of the magnesium oxide film is 400 to 1000 ppm.

3. The plasma display panel according to claim 1,
wherein the silicon content of the magnesium oxide film is 400 to 1050 ppm.

4. The plasma display panel according to claim 1,
wherein the magnesium oxide film is a vacuum-deposited film.

5. A front panel for a plasma display panel, comprising:
a glass substrate;
electrodes arranged on the glass substrate;
a dielectric layer that covers the electrodes; and
a magnesium oxide film laminated onto the dielectric layer,
wherein the magnesium oxide film includes silicon and calcium, the silicon content being 400 to 1050 ppm, and the calcium content being 400 to 1000 ppm.
